(19) United States
(12) Patent Application Publication
(10) Pub. No.: US 2025/0089787 A1
(43) Pub. Date: Mar. 20, 2025

(54) AEROSOL GENERATING DEVICE AND AEROSOL GENERATING SYSTEM INCLUDING THE SAME

(71) Applicant: KT&G CORPORATION, Daejeon (KR)

(72) Inventors: Young Bum KWON, Gyeonggi-do (KR); Dong Sung KIM, Seoul (KR); Yong Hwan KIM, Gyeonggi-do (KR); Hun Il LIM, Seoul (KR)

(73) Assignee: KT&G CORPORATION, Daejeon (KR)

(21) Appl. No.: 18/580,871

(22) PCT Filed: Oct. 19, 2023
(86) PCT No.: PCT/KR2023/016252

§ 371 Date: Jan. 19, 2024

(30) Foreign Application Priority Data
Dec. 30, 2022 (KR) 10-2022-0191111
Mar. 21, 2023 (KR) 10-2023-0036707

(51) Int. Cl. A24F 40/465; A24D 1/20; A24F 40/20; A24F 40/51; A24F 40/53; A24F 40/57; H05B 6/10; H05B 6/36

(52) U.S. Cl. CPC A24F 40/465; A24D 1/20; A24F 40/20; A24F 40/51; A24F 40/53; A24F 40/57; H05B 6/10; H05B 6/36

(57) ABSTRACT

An aerosol generating device includes a housing, an accommodation portion located inside the housing and comprising an accommodation space configured to accommodate at least a portion of an aerosol generating article, and a coil arranged to surround at least one region of an outer circumferential surface of the accommodation portion and configured to generate an alternating magnetic field when power is supplied thereto, wherein the coil includes a first coil having a first resistance value, and a second coil arranged to be spaced apart from the first coil in a first direction in which the accommodation portion extends and having a second resistance value different from the first resistance value.

### TECHNICAL FIELD

Embodiments relate to an aerosol generating device and an aerosol generating system including the same, and more particularly, to an aerosol generating device capable of generating an aerosol through induction heating.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on a heated aerosol generating device is being actively conducted.

Recently, there has been an increasing demand for aerosol generating devices that include various components variously arranged inside aerosol generating articles and efficiently heat the components. Accordingly, research on methods of providing aerosols having uniform and high quality to users through heating has been actively conducted.

### DISCLOSURE

### Technical Problem

An embodiment according to the present disclosure may provide an optimal smoking experience to users by generating an aerosol by heating an aerosol generating article at a certain temperature without burning the aerosol generating article having various components variously arranged therein.

Problems to be solved through the embodiments of the present disclosure are not limited to the problems described above, and problems not mentioned will be clearly understood by one of ordinary skill in the art to which the embodiments belong from the description and the accompanying drawings.

### Technical Solution

According to an aspect of the present disclosure, an aerosol generating device includes a housing, an accommodation portion located inside the housing and including an accommodation space configured to accommodate at least a portion of an aerosol generating article, and a coil arranged to surround at least one region of an outer circumferential surface of the accommodation portion and configured to generate an alternating magnetic field when power is supplied thereto, wherein the coil includes a first coil having a first resistance value, and a second coil arranged to be spaced apart from the first coil in a first direction in which the accommodation portion extends and having a second resistance value different from the first resistance value.

According to another aspect of the present disclosure, an aerosol generating system includes an aerosol generating article including a first medium portion including a first aerosol generating material and a second medium portion including a second aerosol generating material, a housing, an accommodation portion located inside the housing and including an accommodation space configured to accommodate at least a portion of the aerosol generating article, a coil arranged to surround at least one region of an outer circumferential surface of the accommodation portion and configured to generate an alternating magnetic field when power is supplied thereto, and a susceptor configured to heat the aerosol generating article by generating heat in response to the alternating magnetic field generated by the coil, wherein the coil includes a first coil having a first resistance value, and a second coil arranged to be spaced apart from the first coil in a first direction in which the accommodation portion extends and having a second resistance value different from the first resistance value.

### Advantageous Effects

An aerosol generating device according to various embodiments of the present disclosure may simultaneously promote power efficiency and efficient use of an internal space.

The aerosol generating device according to various embodiments of the present disclosure may control to uniformly maintain quality of an aerosol.

### DESCRIPTION OF DRAWINGS

FIG. 1 is a perspective view of an aerosol generating device according to an embodiment.

FIG. 2 is a cutaway, enlarged view illustrating a coil of an aerosol generating device and a partial region of the coil, according to an embodiment.

FIG. 3A is a cutaway, enlarged view illustrating a coil of an aerosol generating device and a partial region of the coil, according to another embodiment.

FIG. 3B is a view schematically illustrating a coil of an aerosol generating device, according to another embodiment.

FIG. 4 is a view schematically illustrating an aerosol generating article according to an embodiment.

FIG. 5A is a view illustrating an arrangement of a coil, according to an embodiment.

FIG. 5B is a view illustrating an arrangement of a coil, according to another embodiment.

FIG. 5C is a view illustrating an arrangement of a coil, according to another embodiment.

FIG. 6 is a cross-sectional view illustrating an arrangement of a coil, according to an embodiment.

FIG. 7 is a block diagram schematically illustrating components of an aerosol generating device according to an embodiment.

FIG. 8 is a flowchart illustrating an operation of controlling power supply to a coil on the basis of a type of an aerosol generating article accommodated in an aerosol generating device, according to an embodiment.

FIG. 9 is a block diagram of an aerosol-generating device according to another embodiment.

### MODE FOR INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er” “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. In other words, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

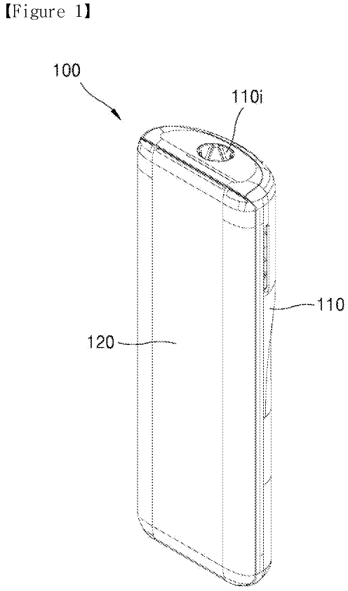

FIG. 1 is a perspective view of an aerosol generating device according to an embodiment.

Referring to FIG. 1, an aerosol generating device 100 according to an embodiment may include a housing 110 forming an overall external appearance of the aerosol generating device 100 and an accommodation portion 110i in at least one region of the housing 110 to accommodate an aerosol generating article.

The aerosol generating device 100 may accommodate an aerosol generating article (not shown) and generate an aerosol by heating the accommodated aerosol generating article. The aerosol generated by the aerosol generating device 100 may be supplied to a user by an inhalation behavior (or a puff behavior) of the user, and the user may smoke according to this process.

The housing 110 may include an accommodation space (or an inner space) in which components of the aerosol generating device 100 may be arranged. The components of the aerosol generating device 100 may be arranged in the accommodation space of the housing 110.

For example, a heater for heating at least one region of the aerosol generating article accommodated in the accommodation portion 110i, a battery for supplying power to the heater, and a processor may be arranged in the accommodation space of the housing 110. Here, the heater may include a coil for generating an alternating magnetic field and a susceptor for generating heat in response to the alternating magnetic field generated by the coil, but is not limited thereto.

In addition, the components described above are only one example of the components of the aerosol generating device 100 that may be arranged in the accommodation space of the housing 110, and the components of the aerosol generating device 100, which may be arranged in the accommodation space of the housing 110, are not limited thereto.

When the aerosol generating article is heated by a heating element, an aerosol may be generated in the accommodation space of the housing 110. The generated aerosol may be discharged to the outside of the aerosol generating device 100 through the aerosol generating article accommodated in the accommodation portion 100i or an empty space between the aerosol generating article and the accommodation portion 100i, and the user may inhale the aerosol that is discharged.

Although the drawing illustrates only an embodiment in which the housing 110 has a cross section formed in a semicircular shape as a whole, the shape of the housing 110 is not limited thereto. According to embodiments (not shown), the housing 110 may be formed to have a cylindrical shape as a whole, or may be formed to have a polygonal pillar shape (e.g., a triangular pillar shape or a rectangular pillar shape).

The aerosol generating device 100 according to an embodiment may further include a display 120 arranged to be exposed in at least one region of an external surface of the housing 110. For example, the display 120 may be arranged to be exposed in at least one region through a cover glass on the external surface of the housing 110.

The display 120 may include a display panel, and a touch panel for receiving a touch input. For example, the display panel may include a light-emitting device (e.g., an organic light-emitting diode (OLED) or a light-emitting diode (LED)) for emitting light on the basis of a scan line, a data line, and signals supplied from the scan line and the data line. The touch panel may detect a change in electrical characteristics (e.g., capacitance, radio waves, and the like) according to a touch input of the user, and location information in which the change is detected may be transmitted to the processor.

The aerosol generating device 100 may provide various types of visual information to the user through the display 120. For example, the aerosol generating device 100 may display, through the display 120, preheating and heating information, battery remaining amount information, time and date information, use mode information, weather information, and Bluetooth connection information regarding the aerosol generating article. The information displayed through the display 120 is an example, and is not limited to the embodiment described above.

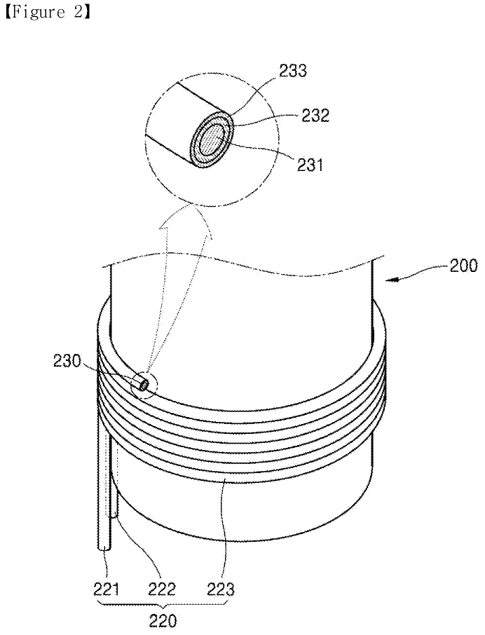

FIG. 2 is a cutaway, enlarged view illustrating a coil of an aerosol generating device and a partial region of the coil, according to an embodiment.

Referring to FIG. 2, an aerosol generating device (e.g., the aerosol generating device 100 of FIG. 1) according to an embodiment may include an accommodation portion 200 and a coil 220.

The accommodation portion 200 may include an accommodation space for accommodating an aerosol generating article, and at least one region of the aerosol generating article may be accommodated inside the accommodation space.

The coil 220 may be arranged to surround at least one region of an outer circumferential surface of the accommodation portion 200, and may generate an alternating magnetic field when power is supplied. Here, a susceptor (not shown) may be arranged inside the accommodation space of the accommodation portion 200 or in the aerosol generating article accommodated in the accommodation space, and may generate heat by an alternating magnetic field generated by the coil 220 to heat the aerosol generating article accommodated in the accommodation space of the accommodation portion 200. An amount of heat generated by the susceptor may increase with a decrease in a resistance value of the coil 220.

The coil 220 according to an embodiment may be implemented in a solenoid shape formed by being wound around the accommodation portion 200 in a first direction in which the accommodation portion 200 extends. When a current is supplied to the coil 220 having the solenoid shape, the coil 220 may generate an alternating magnetic field in an inner space of the coil 220. The generated alternating magnetic field may pass through the accommodation portion 200, and, when the aerosol generating article (not shown) is accommodated in the accommodation portion 200, may pass through the aerosol generating article.

According to an embodiment, a conductive wire 223 forming the coil 220 may include at least one of a conductor 231, an insulator 232, and a bonding body 233 from the inside thereof. The conductor 231 may include a Litz wire formed by twisting strands of a wire, and the coil 220 may be formed into a flat coil having a desired shape by the bonding body 233.

The Litz coil may be a coil formed by weaving about 10 to about 100 strands of a Litz wire that is a thin conductor having a diameter of about 0.1 mm, and may increase a surface area thereof from a physical point of view and improve frequency characteristics from an electrical point of view. Accordingly, an effective resistance of the coil may be reduced by reducing a skin effect, and heating efficiency of the coil may be improved according to a high-frequency alternating current.

The flat coil may have a greater coil cross-sectional area than the Litz coil described above, and thus, an effective resistance thereof may be reduced. In addition, the flat coil may be a single coil, and thus, a distance between adjacent conductive wires may be reduced.

Accordingly, the coil 220 in which the Litz coil is formed into the flat coil may reduce an effective resistance thereof to improve heating efficiency of the coil 220 while miniaturizing the aerosol generating device through efficient use of a space.

The insulator 232 may be formed coaxially with the conductor 231 on an outer surface of the conductor 231. When the conductive wire 223 forming the coil 220 includes the conductor 231 and the insulator 232 and does not include the bonding body 233, production cost may be lowered. However, the bonding body 233 may fix the coil 220 in a desired shape.

When heat treatment is performed on the bonding body 233 while the conductor 231 is wound in a desired shape, bonding may occur between wires, and thus, the coil 220 may be fixed in a desired shape. A heat treatment temperature may be less than or equal to a heat resistance temperature of each of the conductor 231 and the insulator 232 and greater than or equal to a heat resistance temperature of the bonding body 233.

When bonding occurs between wires by performing heat treatment on the bonding body 233, the bonding body 233 may melt, and thus a gap between the conductive wires 223 forming the coil 220 may be minimized. The distance between the conductive wires 223 may be reduced, and thus, an accommodation space of the aerosol generating device may be efficiently used.

The bonding body 233 may include at least one of polyamide, polyvinyl butyral, and polyimide. In an example, the bonding body 233 may include polyamide having high adhesiveness, and a high melting point due to hydrogen bond. In another example, the bonding body 233 may include polyvinyl butyral which may have high adhesiveness and may be produced as thermosetting and thus may be suitable for fixing the coil 220 in a desired shape. In another example, the bonding body 233 may include polyimide which may have high heat resistance to reduce a possibility of phase change of the bonding body 233, have little change in characteristics in a wide temperature range, and have high electrical characteristics.

An inductance value of the coil 220 may be proportional to the number of windings of a wire per unit length as expressed in Equation 1.

$$L = {μ}_{0} {n}^{2} lA \qquad [ Equation 1 ]$$

In Equation 1, ρ_{c} refers to permeability in a vacuum, n refers to the number of windings of the wire per unit length, 1 refers to the length of the coil 220, and A refers to a cross-sectional area of the coil 220.

An electromotive force, which is generated by the coil 220 when an alternating current is supplied, may be proportional to the inductance value of the coil 220 as expressed in Equation 2.

$$V = - L \frac{di}{dt} \qquad [ Equation 2 ]$$

In Equation 2, V refers to the electromotive force, L refers to an inductance of the coil 220, and

$$\frac{di}{dt}$$

refers to a time change rate of the alternating current that is supplied. Accordingly, when the number n of windings of the wire per unit length, the length I of the coil 220, and the cross-sectional area A of the coil 220 (in detail, a cross-sectional area of the coil 220 perpendicular to a longitudinal direction) are greater, the inductance value may increase, and thus, electrical efficiency of the coil 220 may be improved.

According to an embodiment, the coil 220 formed into the flat coil may include a circular coil cross section 230. However, the coil cross section 230 is not limited thereto, and the coil cross section 230 included in the coil 220 formed into the flat coil may be triangular or rectangular.

According to the shape of the coil cross section 230 included in the coil 220 formed into the flat coil, the number of windings of the coil 220 per unit length may vary and the inductance value of the coil 220 may vary. The inductance value of the coil 220 may be controlled by varying the shape, size, number, or the like of the coil cross section 230 included in the coil 220 formed into the flat coil.

The coil 220 having a solenoid shape may include one conductive wire 223, and may have a pair of power supply lines 221 and 222 at both ends thereof.

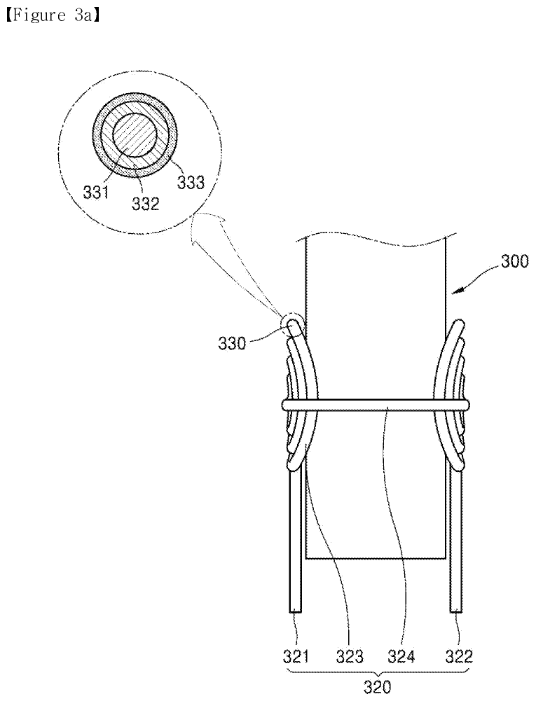

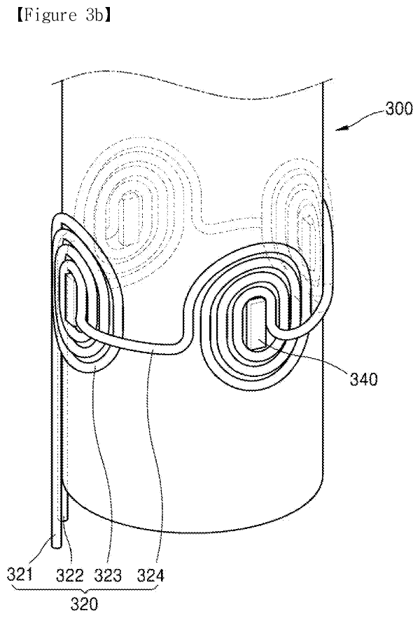

FIG. 3A is a cutaway, enlarged view illustrating a coil of an aerosol generating device and a partial region of the coil, according to another embodiment. FIG. 3B is a view schematically illustrating a coil of an aerosol generating device, according to another embodiment.

A coil 320 having a spiral shape illustrated in FIGS. 3A and 3B may be same as or similar to the coil 220 having the solenoid shape illustrated in FIG. 2, except that a shape and arrangement thereof are changed, and thus, the same descriptions thereof are omitted below.

Referring to FIGS. 3A and 3B, the coil 320 may be arranged to surround at least one region of an outer circumferential surface of an accommodation portion 300. The coil 320 according to an embodiment may be implemented in a spiral shape wound around a central axis extending in a second direction crossing a first direction in which the accommodation portion 300 extends.

In detail, when a current is supplied to the coil 320 illustrated in FIGS. 3A and 3B, the coil 320 may generate an alternating magnetic field inside an accommodation space of the accommodation portion 300, a conductive wire 323 forming the coil 320 illustrated in FIGS. 3A and 3B may include at least one of a conductor 331, an insulator 332, and a bonding body 333 from the inside thereof, and when the coil 320 illustrated in FIGS. 3A and 3B is formed into a flat coil, the coil 320 may include a circular coil cross section 330.

According to an embodiment, the coil 320 may be wound in a shape having a diameter gradually increasing with respect to a central axis arranged at one point on the outer circumferential surface of the accommodation portion 300. The coil 320 may form a curved surface, and may be arranged so that the curved surface surrounds one region of the outer circumferential surface of the accommodation portion 300.

The coil 320 may be wound around central axes spaced apart from each other at a plurality of points on the outer circumferential surface of the accommodation portion 300. For example, the coil 320 illustrated in FIG. 3A may be implemented as two spiral coils 320 formed by being wound around two central axes spaced apart from each other at two points on the outer circumferential surface of the accommodation portion 300.

In addition, the coil 320 may be implemented as spiral coils 320 formed by being respectively wound in a circular shape around a plurality of central axes spaced apart from one another. However, the number, size, or shape of the spiral coils 320 is not limited to the above description, and may be modified as needed.

A magnetic field, which is generated when a current is supplied to the coil 320, follows the Ampere's Law. A direction of a net magnetic field, which is generated according to an arrangement of the coil 320 illustrated in FIGS. 3A and 3B, may be the second direction crossing a direction in which the accommodation portion 300 extends. In contrast, a direction of a net magnetic field, which is generated according to the arrangement of the coil 220 shown in FIG. 2, may be the first direction that is the direction in which the accommodation portion 200 extends.

In detail, with respect to a density of a magnetic field passing through the accommodation portion 300 and an aerosol generating material (not shown) accommodated therein, a magnetic field, which is generated by the coil 320 having the spiral shape illustrated in FIGS. 3A and 3B, may have a greater density than a magnetic field generated by the coil 220 having the solenoid shape illustrated in FIG. 2. Therefore, heating efficiency of the coil 320 having the spiral shape illustrated in FIGS. 3A to 3B may be superior to heating efficiency of the coil 220 having the solenoid shape shown in FIG. 2.

Referring to FIGS. 3A and 3B, the spiral coils 320 may each have the same size and shape and may be connected to each other through a coil connection portion 324. The coil 320 may include one conductive wire 323, and thus may have a pair of power supply lines 321 and 322 at both ends thereof.

Referring to FIG. 3B, the coil 320 may be implemented as four spiral coils 320 formed by being respectively wound around four central axes spaced apart from one another at four points on the outer circumferential surface of the accommodation portion 300. Two pairs of four spiral coils 320 may be arranged to be symmetrical with respect to each other around the accommodation portion 300, and according to the Ampere's Law, a ratio of a magnetic field, which is offset by the arrangement of the spiral coils 320, may be minimized.

Referring to FIG. 3B, a coil support portion 340 may be arranged to protrude from at least one region of the outer circumferential surface of the accommodation portion 300 toward the outside of the accommodation portion 300, but is not limited thereto. In addition, the coil 320 may be implemented as spiral coils 320 wound in a circular shape around the respective coil support portions 340 supporting the respective spiral coils 320. However, even when the coil support portion 340 does not support the coil 320, the coil support portion 340 may perform a function of indicating a location of a central axis around which the coil 320 is wound.

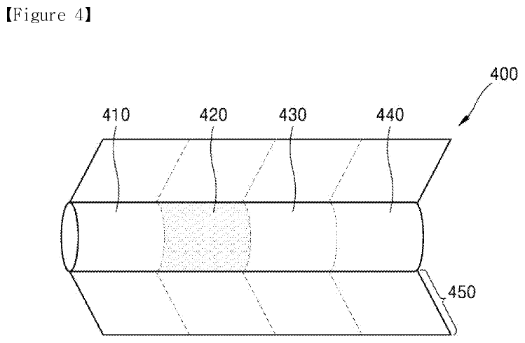

FIG. 4 is a view schematically illustrating an aerosol generating article according to an embodiment.

Referring to FIG. 4, an aerosol generating article 400 may include a first medium portion 410, a second medium portion 420, a cooling portion 430, and a filter portion 440.

In the aerosol generating article 400 according to an embodiment, the first medium portion 410 may include a material for generating atomization, and the second medium portion 420 may include nicotine.

For example, the first medium portion 410 may include at least one of glycerin, propylene glycol, ethylene glycol, dipropylene glycol, diethylene glycol, triethylene glycol, tetraethylene glycol, and oleyl alcohol, but it is not limited thereto. In addition, the first medium portion 410 may not include nicotine.

For example, the second medium portion 420 may be formed as a pipe tobacco, which is formed of tiny bits cut from a tobacco sheet. As another example, the second medium portion 420 may include a material in which a pipe tobacco and a reconstituted tobacco sheet are mixed at a ratio of about 4:1, but is not limited to the mixing ratio described above.

An aerosol generating article (not shown) according to another embodiment may be the same as or similar to the aerosol generating article 400 according to the embodiment, except that only a second medium portion (not shown) thereof is changed, and thus, the same descriptions thereof are omitted below.

For example, the second medium portion may be a crimped sheet impregnated with a nicotine solution. The crimped sheet may be a paper sheet that does not generate off-flavor due to heat even when heated at a high temperature, but is not limited thereto.

An aerosol generating article (not shown) according to another embodiment may be same as or similar to the aerosol generating article 400 according to the embodiment, except that a second medium portion (not shown) thereof is changed, and thus, the same descriptions are omitted below.

For example, the second medium portion may include a plurality of tobacco granules. The tobacco granules may refer to spherical particles including tobacco materials. The plurality of tobacco granules may be buried between filter materials. The second medium portion may include a paper sheet, and a plurality of tobacco granules may be uniformly dispersed inside the wound paper sheet, but is not limited thereto.

The cooling portion 430 may provide a user with an aerosol cooled at an appropriate temperature by generating an effect of lowering a temperature of the generated aerosol. For example, the cooling portion 430 may include cellulose acetate and may be a tube-shaped structure including a hollow. However, the cooling portion 430 is not limited to the example described above and may include any cooling portion, which may generate an effect of cooling an aerosol, without limitation.

The filter portion 440 may include at least one capsule. For example, the capsule may include a flavoring liquid, and a flavor may be generated by the flavoring liquid leaking when the capsule is crushed, but the present disclosure is not limited thereto.

The aerosol generating article 400 may further include a wrapper 450 surrounding an outer circumferential surface of the aerosol generating article 400. The wrapper 450 may include separate wrappers (not shown) surrounding outer circumferential surfaces of respective segments or an external wrapper (not shown) surrounding the entire outer circumferential surface of the aerosol generating article 400.

The aerosol generating article 400 may further include a susceptor (not shown) therein.

A susceptor according to an embodiment may be included in the second medium portion 420. For example, the susceptor may be formed in the form of a sheet or strand, or may be dispersed and arranged within the second medium portion 420 in the form of fine particles.

A susceptor according to another embodiment may be included inside the wrapper 450 surrounding at least a partial region of the outer circumferential surface of the second medium portion 420. The susceptor may include a metal thin film. When the susceptor includes a thinly spread metal thin film, heat generation efficiency of the susceptor may be maximized compared to a mass of the susceptor, and thus, heating efficiency thereof may be improved. Also, the heat generation efficiency of the susceptor may be maximized compared to a volume of the susceptor, and thus, an inner space of an aerosol generating device (not shown) may be efficiently used. The metal thin film may be an aluminum thin film, but is not limited thereto.

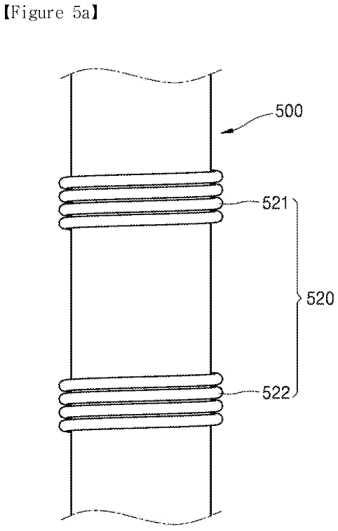

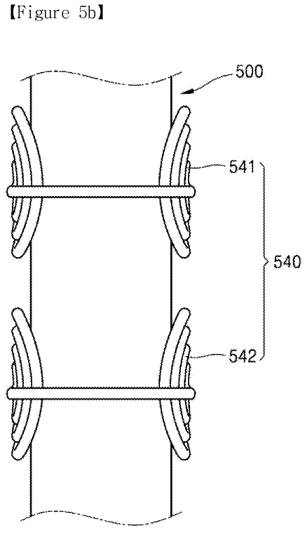

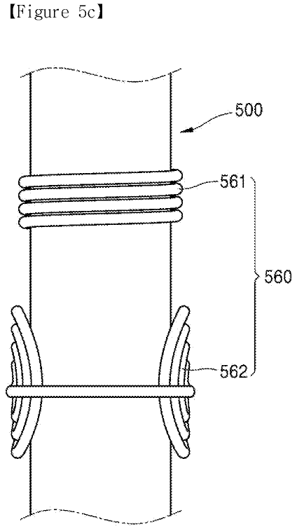

FIG. 5A is a view illustrating an arrangement of a coil, according to an embodiment. FIG. 5B is a view illustrating an arrangement of a coil, according to another embodiment. FIG. 5C is a view illustrating an arrangement of a coil, according to another embodiment.

An aerosol generating device according to an embodiment (e.g., the aerosol generating device 100 of FIG. 1) may include an accommodation portion 500 and a coil 520, 540, or 560. At least one of components of the aerosol generating device may be the same as or similar to at least one of the components of the aerosol generating device shown in FIGS. 2, 3A, and 3B, and thus, the same descriptions are omitted below.

Referring to FIG. 5A, in an example, the coil 520 may include a solenoid-shaped coil in which one or more Litz coils are formed into a flat coil, and the coil 520 may be arranged to surround at least one region of an outer circumferential surface of the accommodation portion 500.

According to an embodiment, a Litz coil may be formed into a flat coil to arrange a solenoid-shaped coil 521 having a first resistance value, and a Litz coil may be formed into a flat coil to arrange a solenoid-shaped coil 522 having a second resistance value different from the first resistance value to be spaced apart from the coil 521 in a first direction in which the accommodation portion 500 extends.

Referring to FIG. 5B, in another example, the coil 540 may include a spiral coil in which one or more Litz coils are formed into a flat coil, and the coil 540 may be arranged to surround at least one region of the outer circumferential surface of the accommodation portion 500.

According to another embodiment, a Litz coil may be formed into a flat coil to arrange a spiral coil 541 having a first resistance value, and a Litz coil may be formed into a flat coil to arrange a spiral coil 542 having a second resistance value different from the first resistance value to be spaced apart from the coil 541 in the first direction in which the accommodation portion 500 extends.

Referring to FIG. 5C, in another example, the coil 560 may include a solenoid-shaped coil in which one or more Litz coils are formed into a flat coil and a spiral coil in which one or more Litz coils are formed into a flat coil, and the coil 560 may be arranged to surround at least one region of the outer circumferential surface of the accommodation portion 500.

According to another embodiment, a Litz coil may be formed into a flat coil to arrange a solenoid-shaped coil 561 having a first resistance value, and a Litz coil may be formed into a flat coil to arrange a spiral coil 562 having a second resistance value different from the first resistance value to be spaced apart from the coil 561 in the first direction in which the accommodation portion 500 extends.

An aerosol generating article (e.g., the aerosol generating article 400 of FIG. 4) according to an embodiment may include a first medium portion (e.g., the first medium portion 410 of FIG. 4) including a material generating atomization and a second medium portion (e.g., the second medium portion 420 of FIG. 4) including nicotine. By heating the aerosol generating article differently for each segment, quality of an aerosol provided to a user may be different. In the present disclosure, quality of an aerosol may refer to a generation amount of aerosol and/or an amount of flavor that the user may feel when inhaling the aerosol, and the corresponding expression may be used in the same sense below.

For example, when the first medium portion 410 is heated relatively more than the second medium portion 420, a generation amount of aerosol provided to the user may increase, and when the second medium portion 420 is heated relatively more than the first medium portion 410, an amount of flavor per unit volume of the aerosol provided to the user may increase.

An aerosol generating system according to an embodiment may include an aerosol generating article and an aerosol generating device.

The aerosol generating article may be the same as or similar to the aerosol generating article 400 illustrated in FIG. 4, and thus, the same descriptions thereof are omitted below. For example, the aerosol generating device may include a coil that is the same as or similar to at least one of the coils 520, 540, and 560 illustrated in FIGS. 5A, 5B and 5C, respectively, and thus, the same descriptions thereof are omitted below.

The aerosol generating device may further include a battery, a processor for controlling power supplied from the battery to the coil, a susceptor for generating heat by a magnetic field generated by the coil when power is supplied to the coil, a sensor for detecting a type of aerosol generating article, a memory storing a temperature profile that allows the processor to supply power according to the type of aerosol generating article, and the like. The components of the aerosol generating device are only an example, but are not limited thereto.

A coil (e.g., the coil 520, 540, or 560 of FIG. 5A, 5B, or 5C) in which a Litz coil is formed into a flat coil may reduce effective resistance thereof to improve heating efficiency of the coil while miniaturizing the aerosol generating device through efficient use of space.

According to a shape of a coil cross section (not shown) included in the coil in which the Litz coil is formed into the flat coil, the number of windings of the coil per unit length may vary and an inductance value of the coil may vary. The inductance value of the coil (e.g., the coil 521, 522, 541, 542, 561, or 562 of FIG. 5A, 5B, or 5C) may be controlled by varying the shape, size, or number of coil cross sections included in the coil in which the Litz coil is formed into the flat coil.

With respect to a density of a magnetic field passing through the accommodation portion 500 and the aerosol generating article (not shown) accommodated therein, a magnetic field generated by a solenoid-shaped coil (e.g., the coil 521, 522, or 561 of FIG. 5A, or 5C) may have a greater density than a magnetic field generated by a spiral coil (e.g., 541, 542, or 562 of FIG. 5B, or 5C), and thus, the magnitude of a desired density of the magnetic field may be controlled.

The aerosol generating device according to an embodiment may simultaneously promote power efficiency and miniaturization of the device by arranging a coil in which a Litz coil is formed into a flat coil, while expanding a range of controlling quality of an aerosol by arranging two coils having a solenoid shape and/or a spiral shape, which are formed to have different resistance values, to surround an outer circumferential surface of a first medium portion or a second medium portion.

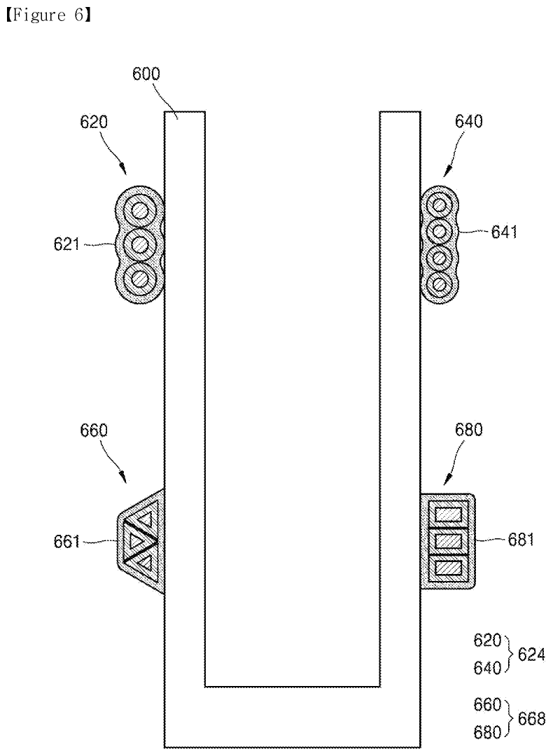

FIG. 6 is a cross-sectional view illustrating an arrangement of a coil, according to an embodiment.

An aerosol generating device according to an embodiment (e.g., the aerosol generating device 100 of FIG. 1) may include an accommodation portion (e.g., the accommodation portion 100i of FIG. 1) and coils 620, 640, 660, and 680. At least one of components of the aerosol generating device may be the same as or similar to at least one of the components of the aerosol generating device illustrated in FIGS. 2, 3A, 3B, and 5A to 5C, and thus, the same descriptions thereof are omitted below.

Referring to FIG. 6 according to an embodiment, a first coil 624 may include coils 620 and 640 in which one or more Litz coils are formed into flat coils, and the first coil 624 may be arranged to surround at least one region of an outer circumferential surface of an accommodation portion 600. The coil 620 of the first coil 624 may be electrically connected to the coil 640 of the first coil 624.

A second coil 668 may include coils 660 and 680 in which one or more Litz coils are formed into flat coils, and the second coil 668 may be arranged to surround at least one region of the outer circumferential surface of the accommodation portion 600. The coil 660 of the second coil 668 may be electrically connected to the coil 680 of the second coil 668.

The first coil 624 having a first resistance value may be arranged in one region of the outer circumferential surface of the accommodation portion 600 to heat a second medium portion (e.g., the second medium portion 420 of FIG. 4), and the second coil 668 having a second resistance value different from the first resistance value may be arranged in another region of the outer circumferential surface of the accommodation portion 600 to heat a first medium portion (e.g., the first medium portion 410 of FIG. 4).

According to an embodiment, the first coil 624 may include the coil 620 including a coil cross section 621 and the coil 640 including a coil cross section 641, and the second coil 668 may include the coil 660 including a coil cross section 661 and the coil 680 including a coil cross section 681.

For example, the coil 620 may include three greater circular coil cross sections 621, and the coil 640 may include four smaller circular coil cross sections 641. In addition, the coil 660 may include five triangular coil cross sections 661, and the coil 680 may include three rectangular coil cross sections 681. In addition, each of the coils 620, 640, 660, and 680 may be a solenoid-shape coil and/or a spiral coil.

The above description is only an example, and may be modified within a range understood by one of ordinary skill in the art to appropriately control quality of an aerosol while simultaneously promoting power efficiency and miniaturization of the device.

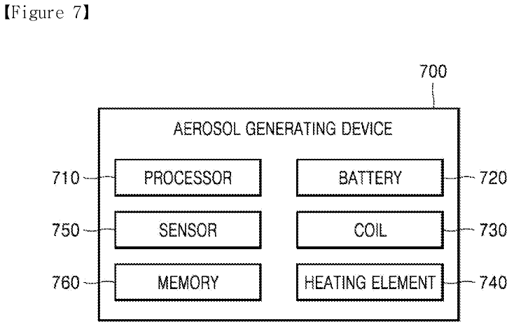

FIG. 7 is a block diagram schematically illustrating components of an aerosol generating device according to an embodiment. An aerosol generating device 700 illustrated in FIG. 7 may be an embodiment of the aerosol generating device 100 illustrated in FIG. 1.

Referring to FIG. 7, the aerosol generating device 700 according to an embodiment may include a processor 710, a battery 720, a coil 730, a heating element 740, a sensor 750, and a memory 760. However, the aforementioned components are an example of the aerosol generating device 700, and the components of the aerosol generating device 700 are not limited to the components shown in FIG. 7.

The processor 710 may be electrically or operatively connected to the battery 720, the coil 730, the heating element 740, the sensor 750 and/or the memory 760 to control overall operation of the aerosol generating device 700. The coil 730 may generate an alternating magnetic field when being supplied with power from the battery 720 under control of the processor 710, and the heating element 740 may electrically generate heat by the generated magnetic field to heat an aerosol generating article (not shown).

The sensor 750 may be an inductance sensor for detecting a type of aerosol generating article accommodated in the aerosol generating device 700. The processor 710 may detect, via the sensor 750, a change in the electrical characteristics inside an accommodation portion, and the processor 710 may detect the type of aerosol generating article accommodated in the accommodation portion (e.g., the accommodation portion 100i of FIG. 1) of the aerosol generating device 700, on the basis of the result of the detection. For example, the processor 710 may detect a type of aerosol generating article determined by a combination of a first medium portion (e.g., the first medium portion 410 of FIG. 4) and a second medium portion (e.g., the second medium portion 420 of FIG. 4) which are included in the aerosol generating article.

The processor 710 may detect, via the sensor 750, the type of aerosol generating article accommodated in the aerosol generating device 700 and output, through a display (e.g., the display 120 of FIG. 1), a user interface (UI) indicating the type of aerosol generating article, on the basis of the type of aerosol generating article that is accommodated.

The processor 710 may control power supplied from the battery 720 to the coil 730, on the basis of the type of aerosol generating article that is detected, and thus may adjust a temperature profile by which the heating element 740 may generate heat to heat the aerosol generating article. The memory 760 may store data regarding the temperature profile corresponding to the type of aerosol generating article that is accommodated.

Referring to FIGS. 5A to 5C described above, power efficiency and miniaturization of the device may be simultaneously promoted by arranging a coil in which a Litz coil is formed into a flat coil. Also, a range for controlling quality of an aerosol may be expanded by arranging two coils having a solenoid shape and/or a spiral shape, which are formed to have different resistance values, to surround an outer circumferential surface of a first medium portion and a second medium portion.

Accordingly, the aerosol generating device 700 may uniformly maintain quality of aerosols of various types of aerosol generating articles in an optimal state by only performing an operation of the processor 710 of controlling power supplied from the battery 720 to the coil 730, according to the temperature profile determined according to the type of aerosol generating article.

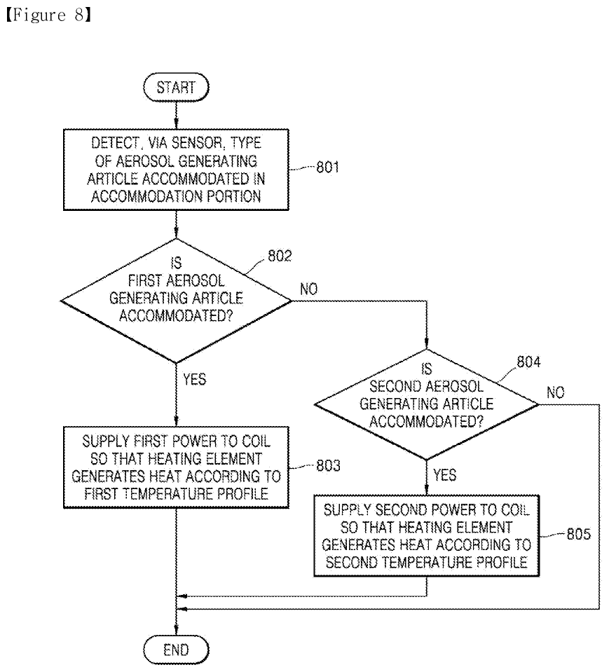

FIG. 8 is a flowchart illustrating an operation of controlling power supply to a coil on the basis of a type of aerosol generating article accommodated in an aerosol generating device, according to an embodiment. Hereinafter, the operation of the aerosol generating device of controlling the power supply is described with reference to the components of the aerosol generating device shown in FIGS. 1 to 7.

Referring to FIG. 8, in operation 801, a processor of an aerosol generating device (e.g., the processor 710 of FIG. 7) may detect, via a sensor (the sensor 750 of FIG. 7), a type of aerosol generating article accommodated in an accommodation portion (e.g., the accommodation portion 100i of FIG. 1). For example, the processor may detect, via the sensor, changes in electrical characteristics inside the accommodation portion, which are detected differently according to the type of aerosol generating article accommodated in the accommodation portion, to detect the type of aerosol generating article accommodated in the accommodation portion.

In operation 802, the processor may determine whether or not a first aerosol generating article is accommodated.

When the first aerosol generating article is determined to be accommodated in the accommodation portion of the aerosol generating device in operation 802, in operation 803, the processor may allow the battery (e.g., the battery 720 of FIG. 7) to supply first power to a coil (e.g., the coil 730 of FIG. 7) so that a heating element (e.g., the heating element 740 of FIG. 7) generates heat according to a first temperature profile. Accordingly, the aerosol generating device may maintain quality of an aerosol of the first aerosol generating article in an optimal state.

In contrast, when the first aerosol generating article is determined not to be accommodated in the accommodation portion of the aerosol generating device in operation 802, in operation 804, the processor may determine whether or not a second aerosol generating article is accommodated.

When the second aerosol generating article is determined to be accommodated in the accommodation portion of the aerosol generating device in operation 804, in operation 805, the processor may allow the battery to supply second power to the coil so that the heating element generates heat according to a second temperature profile. Accordingly, the aerosol generating device may maintain quality of an aerosol of the second aerosol generating article in an optimal state.

Although not shown in the drawing, when the second aerosol generating article is determined not to be accommodated in the accommodation portion of the aerosol generating device in operation 804, the processor may determine whether or not a third aerosol generating article is accommodated. Here, when the third aerosol generating article is determined to be accommodated in the accommodation portion of the aerosol generating device, the processor may allow the battery to supply third power to the coil so that the heating element generates heat according to a third temperature profile, and the aerosol generating device may maintain quality of an aerosol of the third aerosol generating article in an optimal state.

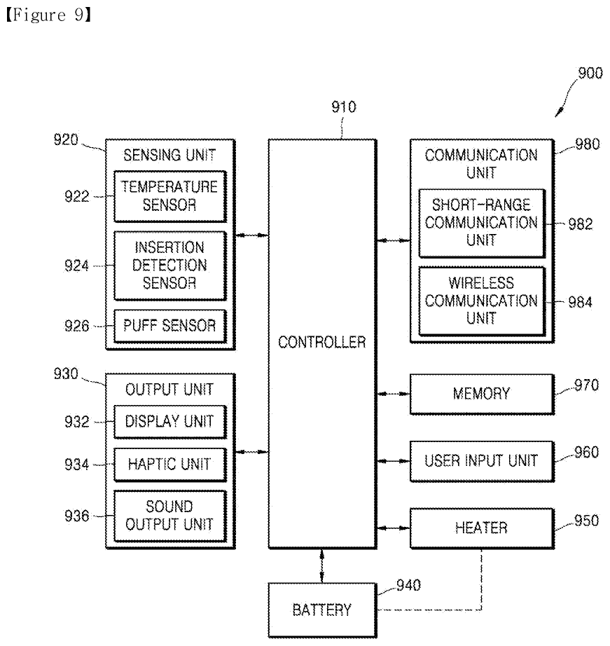

FIG. 9 is a block diagram of an aerosol generating device 900 according to another embodiment.

The aerosol generating device 900 may include a controller 910, a sensing unit 920, an output unit 930, a battery 940, a heater 950, a user input unit 960, a memory 970, and a communication unit 980. However, the internal structure of the aerosol generating device 900 is not limited to those illustrated in FIG. 9. In other words, according to the design of the aerosol generating device 900, it will be understood by one of ordinary skill in the art that some of the components shown in FIG. 9 may be omitted or new components may be added.

The sensing unit 920 may sense a state of the aerosol generating device 900 and a state around the aerosol generating device 900, and transmit sensed information to the controller 910. Based on the sensed information, the controller 910 may control the aerosol generating device 900 to perform various functions, such as controlling an operation of the heater 950, limiting smoking, determining whether an aerosol generating article (e.g., a cigarette, a cartridge, or the like) is inserted, displaying a notification, or the like.

The sensing unit 920 may include at least one of a temperature sensor 922, an insertion detection sensor 924, and a puff sensor 926, but is not limited thereto.

The temperature sensor 922 may sense a temperature at which the heater 950 (or an aerosol generating material) is heated. The aerosol generating device 900 may include a separate temperature sensor for sensing the temperature of the heater 950, or the heater 950 may serve as a temperature sensor. Alternatively, the temperature sensor 922 may also be arranged around the battery 940 to monitor the temperature of the battery 940.

The insertion detection sensor 924 may sense insertion and/or removal of an aerosol generating article. For example, the insertion detection sensor 924 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 926 may sense a user's puff on the basis of various physical changes in an airflow passage or an airflow channel. For example, the puff sensor 926 may sense a user's puff on the basis of any one of a temperature change, a flow change, a voltage change, and a pressure change.

The sensing unit 920 may include, in addition to the temperature sensor 922, the insertion detection sensor 924, and the puff sensor 926 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 930 may output information on a state of the aerosol generating device 900 and provide the information to a user. The output unit 930 may include at least one of a display unit 932, a haptic unit 934, and a sound output unit 936, but is not limited thereto. When the display unit 932 and a touch pad form a layered structure to form a touch screen, the display unit 932 may also be used as an input device in addition to an output device.

The display unit 932 may visually provide information about the aerosol generating device 900 to the user. For example, information about the aerosol generating device 900 may mean various pieces of information, such as a charging/discharging state of the battery 940 of the aerosol generating device 900, a preheating state of the heater 950, an insertion/removal state of an aerosol generating article, or a state in which the use of the aerosol generating device 900 is restricted (e.g., sensing of an abnormal object), or the like, and the display unit 932 may output the information to the outside. The display unit 932 may be, for example, a liquid crystal display panel (LCD), an organic light-emitting diode (OLED) display panel, or the like. The haptic unit 934 may tactilely provide information about the aerosol generating device 900 to the user by converting an electrical signal into a mechanical stimulus or an electrical stimulus.

The haptic unit 934 may tactilely provide information about the aerosol generating device 900 to the user by converting an electrical signal into a mechanical stimulus or an electrical stimulus. For example, the haptic unit 934 may include a motor, a piezoelectric element, or an electrical stimulation device.

The sound output unit 936 may audibly provide information about the aerosol generating device 900 to the user. For example, the sound output unit 936 may convert an electrical signal into a sound signal and output the same to the outside.

The battery 940 may supply power used to operate the aerosol generating device 900. The battery 940 may supply power such that the heater 950 may be heated. In addition, the battery 940 may supply power required for operations of other components (e.g., the sensing unit 920, the output unit 930, the user input unit 960, the memory 970, and the communication unit 980) in the aerosol generating device 900. The battery 940 may be a rechargeable battery or a disposable battery. For example, the battery 940 may be a lithium polymer (LiPoly) battery, but is not limited thereto.

The heater 950 may receive power from the battery 940 to heat an aerosol generating material. Although not illustrated in FIG. 9, the aerosol generating device 900 may further include a power conversion circuit (e.g., a direct current (DC)/DC converter) that converts power of the battery 940 and supplies the same to the heater 950. In addition, when the aerosol generating device 900 generates aerosols in an induction heating method, the aerosol generating device 900 may further include a DC/alternating current (AC) that converts DC power of the battery 940 into AC power.

The controller 910, the sensing unit 920, the output unit 930, the user input unit 960, the memory 970, and the communication unit 980 may each receive power from the battery 940 to perform a function. Although not illustrated in FIG. 9, the aerosol generating device 900 may further include a power conversion circuit that converts power of the battery 940 to supply the power to respective components, for example, a low dropout (LDO) circuit, or a voltage regulator circuit.

In an embodiment, the heater 950 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 950 may be implemented by a metal wire, a metal plate on which an electrically conductive track is arranged, a ceramic heating element, or the like, but is not limited thereto.

In another embodiment, the heater 950 may be a heater of an induction heating type. For example, the heater 950 may include a susceptor that heats an aerosol generating material by generating heat through a magnetic field applied by a coil.

The user input unit 960 may receive information input from the user or may output information to the user. For example, the user input unit 960 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 9, the aerosol generating device 900 may further include a connection interface, such as a universal serial bus (USB) interface, and may connect to other external devices through the connection interface, such as the USB interface, to transmit and receive information, or to charge the battery 940.

The memory 970 is a hardware component that stores various types of data processed in the aerosol generating device 900, and may store data processed and data to be processed by the controller 910. The memory 970 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 970 may store an operation time of the aerosol generating device 900, the maximum number of puffs, the current number of puffs, at least one temperature profile, data on a user's smoking pattern, etc.

The communication unit 980 may include at least one component for communication with another electronic device. For example, the communication unit 980 may include a short-range wireless communication unit 982 and a wireless communication unit 984.

The short-range wireless communication unit 982 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 984 may include a cellular network communication unit, an Internet communication unit, a computer network (e.g., local area network (LAN) or wide area network (WAN)) communication unit, or the like, but is not limited thereto. The wireless communication unit 984 may also identify and authenticate the aerosol generating device 900 within a communication network by using subscriber information (e.g., International Mobile Subscriber Identifier (IMSI)).

The controller 910 may control general operations of the aerosol generating device 900. In an embodiment, the controller 910 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 910 may control the temperature of the heater 950 by controlling supply of power of the battery 940 to the heater 950. For example, the controller 910 may control power supply by controlling switching of a switching element between the battery 940 and the heater 950. The controller 910 may analyze a result sensed by the sensing unit 920 and control subsequent processes to be performed.

The controller 910 may analyze a result sensed by the sensing unit 920 and control subsequent processes to be performed. For example, the controller 910 may control power supplied to the heater 950 to start or end an operation of the heater 950 on the basis of a result sensed by the sensing unit 920. As another example, the controller 910 may control, based on a result sensed by the sensing unit 920, an amount of power supplied to the heater 950 and the time the power is supplied, such that the heater 950 may be heated to a certain temperature or maintained at an appropriate temperature.

The controller 910 may control the output unit 930 on the basis of a result sensed by the sensing unit 920. For example, when the number of puffs counted through the puff sensor 926 reaches a preset number, the controller 910 may notify the user that the aerosol generating device 900 will soon be terminated through at least one of the display unit 932, the haptic unit 934, and the sound output unit 936.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a housing;
an accommodation portion located inside the housing and comprising an accommodation space configured to accommodate at least a portion of an aerosol generating article; and
a coil arranged to surround at least one region of an outer circumferential surface of the accommodation portion and configured to generate an alternating magnetic field when power is supplied thereto, wherein the coil comprises: a first coil having a first resistance value; and a second coil arranged to be spaced apart from the first coil in a first direction in which the accommodation portion extends and having a second resistance value different from the first resistance value.

2. The aerosol generating device of claim 1, wherein, when the first coil or the second coil is cut along a plane passing through each of the first direction and a second direction crossing the first direction, the first coil or the second coil has a cross-sectional area extending in the first direction.

3. The aerosol generating device of claim 1, wherein the first coil or the second coil comprises a conductor, an insulator, and a bonding body, and the conductor comprises a Litz wire formed by twisting strands of a wire.

4. The aerosol generating device of claim 3, wherein the bonding body comprises at least one of polyamide, polyvinyl butyral, and polyimide.

5. The aerosol generating device of claim 1, wherein the first coil or the second coil is wound around a central axis extending in the second direction crossing the first direction.

6. The aerosol generating device of claim 1, wherein the first coil comprises a first portion and a second portion electrically connected to the first portion, and the first portion and the second portion are respectively wound around a plurality of central axes spaced apart from each other.

7. The aerosol generating device of claim 6, wherein the first portion and the second portion are different from each other in at least one of a number, a size, and a shape of cross-sections, and a distance between the cross-sections.

8. The aerosol generating device of claim 6, wherein the second coil comprises a third portion and a fourth portion, and the third portion and the fourth portion are respectively wound around a plurality of central axes spaced apart from each other.

9. The aerosol generating device of claim 8, wherein the third portion and the fourth portion are different from each other in at least one of a number, a size, and a shape of cross-sections, and a distance between the cross-sections.

10. The aerosol generating device of claim 1, wherein the accommodation portion comprises a coil support portion arranged to protrude from at least one region of an outer circumferential surface of the accommodation portion toward outside of the accommodation portion to support the coil.

11. An aerosol generating system comprising:
an aerosol generating article comprising a first medium portion comprising a first aerosol generating material and a second medium portion comprising a second aerosol generating material;
a housing;
an accommodation portion located inside the housing and comprising an accommodation space configured to accommodate at least a portion of the aerosol generating article;
a coil arranged to surround at least one region of an outer circumferential surface of the accommodation portion and configured to generate an alternating magnetic field when power is supplied thereto; and
a susceptor configured to heat the aerosol generating article by generating heat in response to the alternating magnetic field generated by the coil, wherein the coil comprises: a first coil having a first resistance value; and a second coil arranged to be spaced apart from the first coil in a first direction in which the accommodation portion extends and having a second resistance value different from the first resistance value.

12. The aerosol generating system of claim 11, wherein the aerosol generating article further comprises a wrapper arranged to surround at least one region of an outer circumferential surface of the aerosol generating article, and the susceptor comprises a metal thin film and is arranged between the outer circumferential surface of the aerosol generating article and the wrapper.

13. The aerosol generating system of claim 11, wherein the first medium portion comprises at least one of nicotine, a paper filter comprising a nicotine solution, and granules, and the second medium portion comprises glycerin.

14. The aerosol generating system of claim 11, further comprising:
an inductance sensor configured to detect a type of an aerosol generating article accommodated in the accommodation portion; and
a processor electrically connected to the inductance sensor, wherein the processor is configured to control power supplied to a heating element, on the basis of the detected type of the aerosol generating article accommodated in the accommodation portion.

15. The aerosol generating system of claim 14, wherein the processor is configured to: supply first power to the coil so that the susceptor generates heat according to a first temperature profile when a first aerosol generating article is accommodated in the accommodation portion; and supply second power to the coil so that the susceptor generates heat according to a second temperature profile when a second aerosol generating article is accommodated in the accommodation portion.
